(19) United States
(12) Patent Application Publication
(10) Pub. No.: US 2009/0269640 A1
(43) Pub. Date: Oct. 29, 2009

(54) SEPARATOR FOR FUEL CELL

(76) Inventors: Yoshinori Yamamoto, Aichi (JP); Yuichi Yagami, Shizuoka (JP); Jiro Aizaki, Aichi (JP); Junichi Shirahama, Aichi (JP)

Correspondence Address: KENYON & KENYON LLP, 1500 K STREET N.W., SUITE 700, WASHINGTON, DC, 20005, US

(21) Appl. No.: 12/297,297

(22) PCT Filed: Apr. 23, 2007
(86) PCT No.: PCT/JP2007/059279

§ 371 Date: Oct. 15, 2008

(30) Foreign Application Priority Data
Apr. 25, 2006 (JP) 2006-121182

(51) Int. Cl. H01M 8/04

(52) U.S. Cl. 429/26

(57) ABSTRACT

Miniaturization is achieved when a membrane-electrode assembly (MEA) is provided with a cutout, and the flow of a fluid is further smoothened. To realize this, in a separator for a fuel cell according to the present invention, a portion of the contour of a manifold formed in the separator corresponding to a cutout of the membrane-electrode assembly is formed into a shape along the cutout, and a reactant gas or a coolant is supplied or discharged through a portion formed into the shape along the cutout. The cutout is, for example, a corner cut provided in the corner of the membrane-electrode assembly and forming the membrane-electrode assembly into an asymmetric shape. A portion of the contour of the manifold facing this corner cut is preferably formed substantially in parallel with the edge of the corner cut.

### BACKGROUND OF THE INVENTION

1. Field of the Invention

The present invention relates to a separator for a fuel cell. More particularly, the present invention relates to the improvement of the structure and shape of a separator provided with a manifold for supplying to or discharging from each cell a reactant gas or a coolant.

2. Description of Related Art

In general, a fuel cell (e.g., a polymer electrolyte fuel cell) has a structure in which a membrane-electrode assembly (MEA) is held between a pair of separators to constitute a cell (a cell constituting the fuel cell) and in which a plurality of cells are laminated. Moreover, the separator is provided with a manifold for supplying to or discharging from each cell a reactant gas (a fuel gas, an oxidizing gas) or a coolant.

In a case where the above-mentioned fuel cell is manufactured, when the membrane-electrode assembly is arranged on the separator to form a module, for example, it needs to be prevented that an anode and a cathode are wrongly combined during the assembling of the membrane-electrode assembly or that the membrane-electrode assembly is attached inside out. Heretofore, as a technology for preventing the occurrence of such wrong combining or wrong assembling during the formation of the module, it has been suggested that the corner of the membrane-electrode assembly be beforehand cut into an asymmetric shape to form a cutout (a corner cut) as a marker (e.g., see Patent Document 1).

[Patent Document 1] Japanese Patent Application Laid-Open No. 2003-331851

### SUMMARY OF THE INVENTION

However, a membrane-electrode assembly having a shape provided with a marker such as a corner cut as described above has not sufficiently been investigated from a viewpoint of coordination with the structure of a separator. Accordingly, it cannot be said that the miniaturization of the separator is sufficiently achieved. Moreover, when further coordination of the membrane-electrode assembly with the separator is achieved, the flow of a fluid in a fuel cell can further be smoothened.

Therefore, an object of the present invention is to provide a separator capable of achieving miniaturization in a case where a membrane-electrode assembly (MEA) is provided with a cutout and capable of further smoothening the flow of a fluid, and to provide a fuel cell.

To solve such a problem, according to the present invention, there is provided a separator for a fuel cell which is laminated together with a membrane-electrode assembly to constitute a cell and which is provided with a manifold to supply to or discharge from each cell at least one of a reactant gas and a coolant, wherein a portion of the contour of the manifold corresponding to a cutout of the membrane-electrode assembly is formed into a shape along the cutout, and the reactant gas or the coolant is supplied or discharged through the portion formed into the shape along the cutout.

In this separator, a part of the contour of the manifold has a shape along the cutout of the membrane-electrode assembly, and the gas or the coolant to be supplied from the manifold to the cells and to be discharged from the cells to the manifold can be supplied and discharged through the portion along the cutout. In consequence, the reactant gas or the coolant can further smoothly be supplied and discharged. Furthermore, according to such a separator, the coordination with the membrane-electrode assembly having a shape provided with a marker improves, and eventually a compact structure can be realized as a whole to achieve further miniaturization.

The cutout is, for example, a corner cut provided in the corner of the membrane-electrode assembly and forming the membrane-electrode assembly into an asymmetric shape. Moreover, in this case, a portion of the contour of the manifold facing the corner cut is preferably formed substantially in parallel with the edge of the corner cut. In this case, any portion between the corner cut of the membrane-electrode assembly and the portion of the manifold facing the corner cut has an equal width. That is, the length of a supply or discharge passage connecting the manifold to a power generation or the like becomes the shortest through any portion, so that a pressure loss (a differential pressure) can be decreased, and a loss in an auxiliary device or the like can further be decreased.

Moreover, in the separator according to the present invention, a frame member having a passage of the reactant gas is interposed between the separators or between the separator and the membrane-electrode assembly. In this case, the passage of the frame member is preferably formed between the edge of the corner cut and the manifold. Moreover, it is further preferable that the passage of the frame member is formed vertically to the edge of the corner cut. It is also preferable that a plurality of passages of the reactant gas are provided.

A fuel cell according to the present invention has any constitution of the above-mentioned separator.

### BRIEF DESCRIPTION OF THE DRAWINGS

FIG. 1 is a side view showing one example of the structure of a fuel cell;

FIG. 2 is an exploded perspective view showing one embodiment of the present invention and showing cells of a separator of the fuel cell of the present embodiment in an exploded manner;

FIG. 3 is a partial plan view showing a shape example of the separator around a cutout of an MEA; and

FIG. 4 is a partial plan view showing a shape example of a portion corresponding to the separator shown in FIG. 3.

### DETAILED DESCRIPTION OF PREFERRED EMBODIMENT

A preferable embodiment of the present invention will hereinafter be described with reference to the drawings.

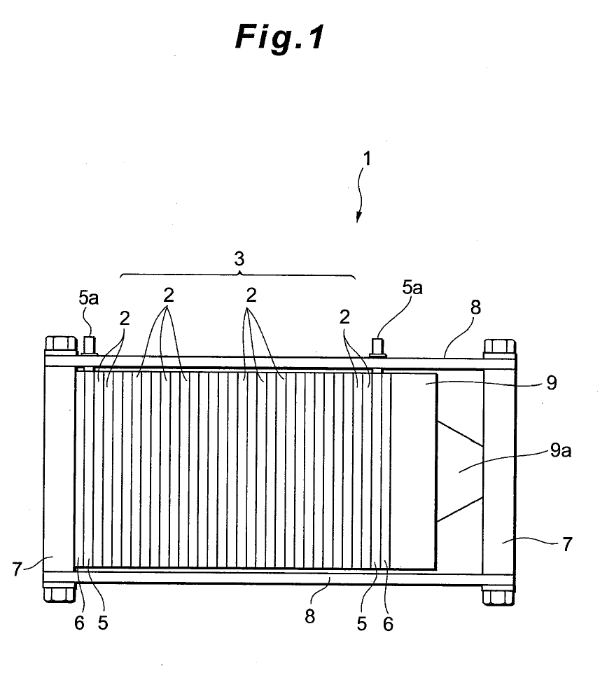

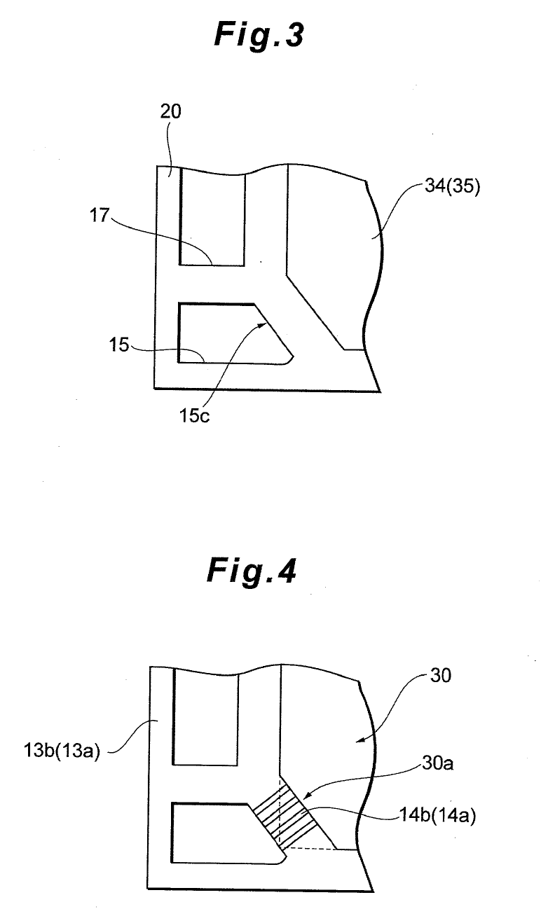

FIGS. 1 to 4 show embodiments of a fuel cell and a separator for the fuel cell according to the present invention. A separator 20 of a fuel cell 1 is laminated together with a membrane-electrode assembly 30 to constitute a cell 2, and includes manifolds 15, 16 and 17 for supplying to or discharging from the cells 2 a reactant gas and a coolant. In the present embodiment, as to this separator 20, portions of the contours of the manifolds 15, 16 and 17 corresponding to a cutout 30a of the membrane-electrode assembly 30 are formed into a shape along the cutout 30a, and the reactant gas or the coolant is supplied or discharged through the portions having the shape along the cutout 30a (see FIG. 3, etc.).

In the embodiment described hereinafter, first the schematic constitution of the fuel cell 1 and the schematic constitution of the cell 2 constituting the fuel cell 1 will be described. Afterward, the shape and the like of the manifolds formed in the separator will be described.

The fuel cell 1 includes a cell laminate 3 in which a plurality of cells 2 are laminated, and terminal plates 5 provided with output terminals 5a, insulators (insulating plates) 6 and end plates 7 are further disposed externally from the laminating direction of the end cells 2 positioned at both ends of the cell laminate 3 (see FIG. 1). A predetermined compressive force is added to the cell laminate 3 in the laminating direction by tension plates 8 extended so as to connect the end plates 7 to each other. Furthermore, a pressure plate 9 and a spring mechanism 9a are provided between the end plate 7 and the insulator 6 on one end side of the cell laminate 3, so that the fluctuations of loads exerted on the cells 2 are absorbed.

The terminal plate 5 is a member which functions as a collector plate. For example, a meal such as iron, stainless steel, copper or aluminum is formed into a plate-like shape. The surface of the terminal plate 5 on the side of the end cell 2 is subjected to a surface treatment such as a plating treatment, and such a surface treatment secures a contact resistance with the end cell 2. Examples of plating include gold, silver, aluminum, nickel, zinc and tin. In the present embodiment, the surface of the terminal plate is subjected to, for example, a tin plating treatment in consideration of conductivity, workability and inexpensiveness.

The insulator 6 is a member which performs a function of electrically insulating the terminal plate 5 and the end plate 7. To perform such a function, this insulator 6 is formed of a resin material such as polycarbonate into a plate-like shape. Moreover, when engineering plastic having an excellent heat resistance is employed as the material of the insulator 6, the insulator advantageously becomes robust, and the fuel cell 1 can preferably be lightened.

The end plate 7 is formed of any type of metal (iron, stainless steel, copper, aluminum or the like) into a plate-like shape in the same manner as in the terminal plate 5. In the present embodiment, this end plate 7 is formed using, for example, copper, but this is merely one example, and the end plate may be formed of another metal.

It is to be noted that this fuel cell 1 can be used as, for example, a car mounted power generation system of a fuel cell hybrid vehicle (FCHV), but this is not restrictive, and the fuel cell may be used as a power generation system to be mounted on any type of mobile body (e.g., a ship, an airplane or the like) or a self-propelled body such as a robot, or as the stationary fuel cell 1.

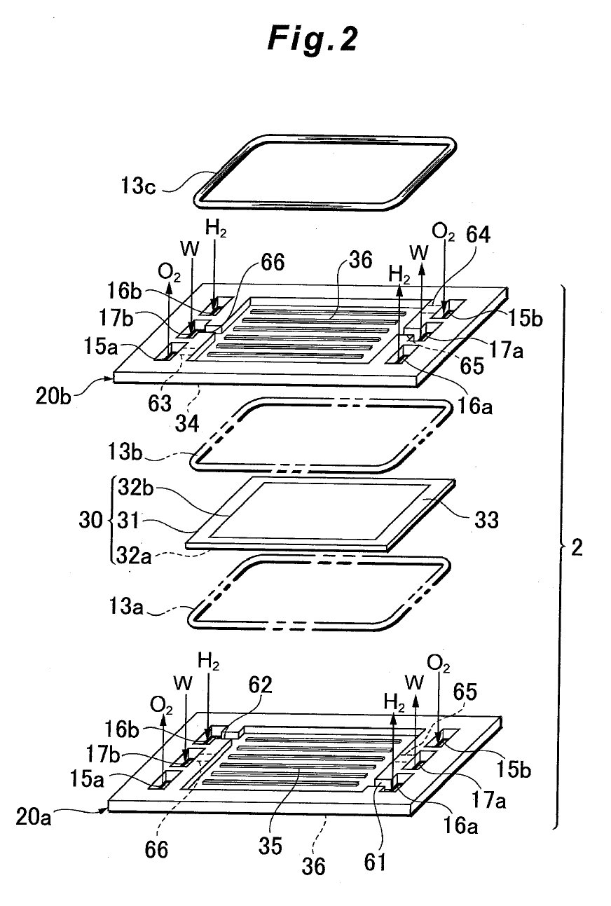

FIG. 2 shows the schematic constitution of the cell 2 of the fuel cell 1 in the present embodiment.

The cell 2 is constituted of a membrane-electrode assembly (hereinafter referred to as the MEA) 30 as a specific example of an electrolyte, and a pair of separators 20 (denoted with symbols 20a, 20b in FIG. 2) between which the MEA 30 is held (see FIG. 2). The MEA 30 and the respective separators 20a, 20b are formed into an approximately rectangular plate-like shape. Furthermore, the MEA 30 is formed so that its outer shape is smaller than that of the respective separators 20a, 20b. In addition, the peripheral portions between the MEA 30 and the separators 20a, 20b are molded together with a first frame member 13a and a second frame member 13b.

The MEA 30 is constituted of a polymeric electrolyte membrane (hereinafter referred to also simply as the electrolyte membrane) 31 constituted of an ion exchange membrane of a polymeric material, and a pair of electrodes 32a, 32b (an anode and a cathode) which sandwich the electrolyte membrane 31 from both the surfaces thereof. The electrolyte membrane 31 of them is formed so as to be slightly larger than the respective electrodes 32a, 32b. To this electrolyte membrane 31, the respective electrodes 32a, 32b are joined by, for example, hot pressing, a peripheral edge 33 of the electrolyte membrane being left.

The electrodes 32a, 32b which constitute the MEA 30 are made of, for example, a porous carbon material (a diffusion layer) on which a catalyst such as platinum attached to the surfaces of the electrodes is carried. To the one electrode (anode) 32a, a hydrogen gas as a fuel gas (a reactant gas) is supplied, and to the other electrode (cathode) 32b, an oxidizing gas (a reactant gas) such as air or an oxidizing agent is supplied. These two kinds of reactant gases electrochemically react in the MEA 30 to obtain the electromotive force of the cell 2.

The separators 20a, 20b are constituted of a gas-impermeable conductive material. Examples of the conductive material include carbon, conductive hard resins, and metals such as aluminum and stainless steel. In the present embodiment, the separators 20a, 20b are made of a base material of a plate-like metal (metal separators), and on the surfaces of the electrodes 32a, 32b of this base material, membranes having excellent corrosion resistance (e.g., membranes formed by gold plating) are formed.

Moreover, on both the surfaces of the separators 20a, 20b, groove-like passages constituted of a plurality of recesses are formed. In a case where the separators 20a, 20b in the present embodiment are made of a base material of, for example, the plate-like metal, these passages can be formed by press molding. The thus formed groove-like passages constitute gas passages 34 of the oxidizing gas, gas passages 35 of a hydrogen gas, or cooling water passages 36. More specifically, on the inner surface of the separator 20a on the side of the electrode 32a, the plurality of hydrogen gas passages 35 are formed, and on the back surface (the outer surface) of the separator, the plurality of cooling water passages 36 are formed (see FIG. 2). Similarly, on the inner surface of the separator 20b on the side of the electrode 32b, the plurality of oxidizing gas passages 34 are formed, and on the back surface (the outer surface) of the separator, the plurality of cooling water passages 36 are formed (see FIG. 2). For example, in the case of the present embodiment, the gas passages 34 and the gas passages 35 in the cell 2 are formed so that they are parallel with each other. Furthermore, in the present embodiment, the cooling water passages 36 of both the separators in the two adjacent cells 2, 2 are integrally configured to form passages having, for example, a rectangular section when the outer surface of the separator 20a of the one cell 2 is joined to the outer surface of the separator 20b of the adjacent cell 2 (see FIG. 2). The peripheral portions between the separators 20a and 20b of the adjacent cells 2, 2 are molded together with the frame member.

Furthermore, around the ends of the separators 20a, 20b in a longitudinal direction (in the vicinity of one end shown on the left side as one faces FIG. 2 according to the present embodiment), there are formed manifolds 15a on the inlet side of the oxidizing gas, manifolds 16b on the outlet side of the hydrogen gas and manifolds 17b on the outlet side of the cooling water. For example, in the present embodiment, these manifolds 15a, 16b and 17b are formed of through holes provided in the respective separators 20a, 20b (see FIG. 2). Furthermore, the opposite ends of the separators 20a, 20b are provided with manifolds 15b on the outlet side of the oxidizing gas, manifolds 16a on the inlet side of the hydrogen gas and manifolds 17a on the inlet side of the cooling water. In the present embodiment, these manifolds 15b, 16a and 17a are also formed of through holes (see FIG. 2). It is to be noted that in FIG. 2, the cooling water is denoted with symbol W.

Among the above manifolds, the inlet-side manifold 16a and the outlet-side manifold 16b for the hydrogen gas in the separator 20a communicate with the gas passages 35 of the hydrogen gas via an inlet-side communication passage 61 and an outlet-side communication passage 62 formed as groove-like passages in the separator 20a, respectively. Similarly, the inlet-side manifold 15a and the outlet-side manifold 15b for the oxidizing gas in the separator 20b communicate with the gas passages 34 of the oxidizing gas via an inlet-side communication passage 63 and an outlet-side communication passage 64 formed as groove-like passages in the separator 20b, respectively (see FIG. 2). Furthermore, the inlet-side manifolds 17a and the outlet-side manifolds 17b for the cooling water in the respective separators 20a, 20b communicate with the cooling water passages 36 via inlet-side communication passages 65 and outlet-side communication passages 66 formed as groove-like passages in the respective separators 20a, 20b, respectively. According to the above-mentioned constitution of the respective separators 20a, 20b, the oxidizing gas, the hydrogen gas and the cooling water are fed to the cell 2. Here, a typical example will be described. For example, the hydrogen gas passes through the communication passage 61 from the inlet-side manifold 16a of the separator 20a to flow into the gas passage 35, and is used for the power generation of the MEA 30. Afterward, the gas passes through the communication passage 62, and is discharged to the outlet-side manifold 16b.

Both the first frame member 13a and the second frame member 13b are frame-like members substantially formed into the same shape (see FIG. 2). The first frame member 13a of them is provided between the MEA 30 and the separator 20a. More specifically, the first frame member is interposed between the peripheral edge 33 of the electrolyte membrane 31 and a portion of the separator 20a around the gas passage 35. Moreover, the second frame member 13b is provided between the MEA 30 and the separator 20b. More specifically, the second frame member is interposed between the peripheral edge 33 of the electrolyte membrane 31 and a portion of the separator 20b around the gas passages 34.

Furthermore, a frame-like third frame member 13c is provided between the separator 20b and the separator 20a of the adjacent cells 2, 2 (see FIG. 2). This third seal member 13c is a member interposed between a portion of the separator 20b around the cooling water passages 36 and a portion of the separator 20a around the cooling water passages 36 to seal between these portions. Additionally, in the cell 2 of the present embodiment, among various fluid passages (34 to 36, 15a, 15b, 16a, 16b, 17a, 17b, 61 to 66) in the separators 20a, 20b, the inlet-side manifolds 15a, 16a and 17a and the outlet-side manifolds 15b, 16b and 17b for the respective fluids are passages positioned outside the third frame member 13c (see FIG. 2).

Here, FIG. 2 does not especially show the shape of the respective manifolds 15a to 17b, and the shape of the MEA 30, and they will hereinafter be described (see FIGS. 3, 4). It is to be noted that in the following description, the respective manifolds are simply denoted with reference numerals 15, 16 and 17 (see FIGS. 3, 4).

In the present embodiment, a part (e.g., a corner) of the MEA 30 is provided with the cutout 30a so that the MEA has an asymmetric shape as a whole (see FIG. 4). This cutout (the corner cut) 30a functions as a marker in a case where the MEA 30 is arranged on the separator 20 to constitute the module. When this cutout is used, it can be prevented, for example, during the assembling of the MEA 30 that the anode and the cathode are wrongly combined or that the cutout 30a is attached inside out. That is, the occurrence of the wrong combining or assembling can be prevented.

Moreover, the separator 20 provided with the MEA 30 in this manner has a corner formed into a shape corresponding to the cutout 30a (see FIG. 3). More specifically, the shape of an in-plane gas passage (i.e., the gas passage 34 of the oxidizing gas, the gas passage 35 of the hydrogen gas) provided with the MEA 30 having a partially cut shape in this manner is adapted to the shape of the MEA 30. In the separator 20 shown in, for example, FIG. 3, the corner of the gas passage 34 of the oxidizing gas has a shape (a tilted shape) adapted to the MEA 30. It is to be noted that although not especially shown in the drawing, in a separator adjacent to the separator 20 shown in FIG. 3, for example, a portion of the gas passage 34 of the hydrogen gas corresponding to the cutout 30a similarly has a tilted shape.

Furthermore, in the present embodiment, portions of the manifolds 15, 16 and 17 corresponding to the cutout 30a of the MEA 30 are formed into a shape along this cutout 30a. More specifically, a portion (a portion in the vicinity of the cutout 30a, a portion facing the cutout 30a or the like) of the contour of the manifold 15 for the oxidizing gas corresponding to the cutout 30a of the MEA 30 is formed into a shape along the cutout 30a (see FIG. 3). It is to be noted that in FIG. 3, the portion of the contour of the manifold 15 for the oxidizing gas having the shape along the cutout 30a is denoted with symbols 15c.

Moreover, in the present embodiment, the oxidizing gas can be supplied or discharged through the portion 15c of the contour of the manifold 15 for the oxidizing gas having the shape along the cutout 30a. This will hereinafter specifically be described. That is, a portion of the above second frame member 13b positioned between the cutout 30a of the MEA 30 and the manifold 15 is provided with a groove 14b for supplying or discharging the gas (the oxidizing gas in this case), and the gas can be supplied or discharged through this groove 14b (see FIG. 4). In this case, the groove 14b is not limited to one groove, and a plurality of grooves are preferably provided as shown in, for example, FIG. 4 in a case where the strength of, for example, the frame member 13b in the corresponding portion and the like are considered.

Here, the first frame member 13a and the second frame member 13b will additionally be described hereinafter. That is, these frame members 13a, 13b are formed of, for example, a resin, have non-conductivity, function as a spacer between the separators 20 or as a reinforcing member or the like to reinforce the rigidity of the separator 20, and function so as to secure higher insulation if necessary. Moreover, the frame members 13a, 13b seal between members (the frame member and the separator 20 or another frame member) disposed adjacent to each other in a cell laminating direction, and further seal between manifolds (the manifold 15 for the oxidizing gas, the manifold 16 for the hydrogen gas, the manifold 17 for the cooling water). It is to be noted that in FIG. 2, these frame members 13a, 13b are schematically shown by imaginary lines, and these frame members 13a, 13b are formed into such a hollow shape as to surround the MEA 30 and the respective manifolds 15 to 17 as shown in, for example, FIG. 4.

Furthermore, in the present embodiment in which the MEA 30 is provided with the cutout 30a by corner cutting, the portion 15c of the contour of the manifold 15 having the shape along the cutout (corner cut) 30a is formed in parallel with the edge of the corner cut (see FIG. 3). In addition, a portion of the frame member 13b having a shape along the cutout (corner cut) 30a is similarly formed in parallel (see FIG. 4). In this case, any portion of the separator 20 (or a portion of the frame member 13b provided with the groove 14b) between cutout (corner cut) 30a of the MEA 30 and the corresponding shape portion 15c has an equal width.

In addition, the passage of the reactant gas (the oxidizing gas) between the edge of the cutout (corner cut) 30a and the manifold 15 is preferably vertical to the edge of the cutout 30a. In the present embodiment, the groove 14b formed in the frame member 13b is formed vertically to the edge of the cutout 30a (see FIG. 4). In this case, the length of a supply or discharge passage (the groove 14b) connecting the manifold 15 to a power generation region or the like becomes uniform, and becomes shortest through any portion. Therefore, there are advantages that a pressure loss (a differential pressure) can be decreased and that a low in an auxiliary device or the like can further be decreased. In addition, the “pressure loss” indicates that energy such as the pressure of the fluid is consumed owing to the shape of the fluid passage, the smoothness of the surface of the fluid passage or the like.

It is to be noted that although not especially shown in detail, the passage of the reactant gas (the oxidizing gas) formed vertically to the edge of the cutout 30a includes the vertically formed communication passages 63, 64 shown in FIG. 2.

As described above, according to the separator 20 and the fuel cell 1 of the present embodiment, when the MEA 30 is provided with a marker such as the cutout 30a, the manifold 15 (16, 17) having the shape or constitution corresponding to the cutout 30a is provided, and the reactant gas and the like can be supplied or discharged through the cutout. Therefore, when this separator 20 is used, the reactant gas and the like can smoothly be supplied or discharged. Thus, according to the separator 20 described in the present embodiment, coordination with the MEA 30 provided with the marker improves. In consequence, while securing a necessary seal performance, a compact structure can be realized as a whole.

It is to be noted that the above embodiment is one example of the preferable embodiment according to the present invention, but this is not restrictive, and the present invention can variously be modified and implemented without departing from the scope of the present invention. For example, in the above embodiment, an example in which a part of the contour of the manifold 15 for the oxidizing gas is formed into the shape along the cutout 30a has been described, but this is merely one example, and the present invention is not limited to such a configuration. That is, conversely, when the cutout 30a provided in the MEA 30 is formed in the vicinity of the manifold 16 for the hydrogen gas, a part of the contour of the manifold 16 for the hydrogen gas may be formed into the shape along the cutout 30a. Even in this case, advantages such as miniaturization and smoother supply or discharge can be obtained in the same manner as described above.

Moreover, the present invention can be applied not only to the reactant gas (the hydrogen gas, the oxidizing gas) but also to the manifold 17 for a coolant such as cooling water. That is, when the cutout 30a of the MEA 30 is formed, for example, in the vicinity of the manifold 17 of the cooling water, a part of the contour of the manifold 17 may be formed into the shape along the cutout 30a. Even in this case, the miniaturization of the separator 20 and the smooth supply or discharge of the cooling water can be achieved in the same manner as described above.

Furthermore, in the above embodiment, an example in which the passages 34 to 36 of the respective fluids are straight passages has been described (see FIG. 2), but this is not restrictive, and needless to say, the present invention can be applied even to, for example, a serpentine passage.

Moreover, in the above embodiment, as the gas-impermeable conductive material constituting the separator 20, carbon, a conductive hard resin, a metal such as aluminum or stainless steel or the like has been illustrated. The present invention can be applied not only to a case where the separator is constituted of such a material but also to a case where the separator is constituted of another material.

Furthermore, in the above embodiment, there has been described a case where the cutout 30a of the MEA 30 is linearly formed (corner cut) and the shape portion 15c of the contour of the manifold 15 along this cutout is formed in parallel, but this is also merely one example. If the cutout 30a is constituted of a curve, a part of the contour of the manifold 15 (16, 17) is formed along this curve. In this case, function and effect similar to those described above can be obtained. Therefore, the present invention can be applied not only to a case where these straight shapes are formed but also to a case where the curve shape or the combined shape of the curve and the straight line is formed.

### INDUSTRIAL APPLICABILITY

According to the present invention, when a membrane-electrode assembly (MEA) is provided with a cutout, a separator and a fuel cell 1 can be miniaturized. Moreover, a part of a manifold is formed into a shape along a cutout of the membrane-electrode assembly, and a reactant gas and the like are supplied or discharged through the cutout, so that the flow of these fluids can further be smoothened.

Therefore, the present invention can broadly be used in the separator for the fuel cell 1 having such requirements.

1. A separator for a fuel cell which is laminated together with a membrane-electrode assembly to constitute a cell and which is provided with a manifold to supply to or discharge from each cell at least one of a reactant gas and a coolant,
wherein a portion of the contour of the manifold corresponding to a cutout of the membrane-electrode assembly is formed into a shape along the cutout, and the reactant gas or the coolant is supplied or discharged through the portion formed into the shape along the cutout, and
the cutout is provided in a part of the membrane-electrode assembly so that the membrane-electrode assembly has an asymmetric shape as a whole.

2. The separator for the fuel cell according to claim 1, wherein the cutout is a corner cut provided in the corner of the membrane-electrode assembly and forming the membrane-electrode assembly into the asymmetric shape.

3. The separator for the fuel cell according to claim 1, wherein a portion of the contour of the manifold facing the corner cut is formed substantially in parallel with the edge of the corner cut.

4. The separator for the fuel cell according to claim 1, wherein a frame member having a passage of the reactant gas is interposed between the separators or between the separator and the membrane-electrode assembly.

5. The separator for the fuel cell according to claim 4, wherein the passage of the frame member is formed between the edge of the corner cut and the manifold.

6. The separator for the fuel cell according to claim 5, wherein the passage of the frame member is formed vertically to the edge of the corner cut.

7. The separator for the fuel cell according to claim 4, wherein a plurality of passages of the reactant gas are provided.

8. A fuel cell which comprises the separator according to claim 1.
